(19) United States
(12) Patent Application Publication
(10) Pub. No.: US 2023/0072426 A1
(43) Pub. Date: Mar. 9, 2023

(54) INFORMATION PROCESSING DEVICE, INFORMATION PROCESSING METHOD, AND STORAGE MEDIUM STORED WITH INFORMATION PROCESSING PROGRAM

(71) Applicant: TOYOTA JIDOSHA KABUSHIKI KAISHA, Toyota-shi (JP)

(72) Inventors: Masao YANO, Shizuoka-ken (JP); Tetsuya Shoji, Shizuoka-ken (JP); Hirotaka Sakamoto, Kanagawa-ken (JP); Tomoya Itakura, Nagoya-shi (JP)

(73) Assignee: TOYOTA JIDOSHA KABUSHIKI KAISHA, Toyota-shi (JP)

(21) Appl. No.: 17/892,617

(22) Filed: Aug. 22, 2022

(30) Foreign Application Priority Data
Sep. 9, 2021 (JP) 2021-147188

(51) Int. Cl. G06F 16/21

(52) U.S. Cl. CPC G06F 16/211

(57) ABSTRACT

An information processing device receives material data related to a material, from a user terminal. The information processing device performs analysis on the material data using a predetermined first analysis method and generates first analysis result data that is an analysis result from the first analysis method. The information processing device performs analysis on the received material data using a second analysis method and generates second analysis result data that is an analysis result expressing a relationship between the received material data and data different from the received material data. The information processing device transmits the first analysis result data and the generated second analysis result data to the user terminal.

### CROSS-REFERENCE TO RELATED APPLICATION

This application is based on and claims priority under 35 USC 119 from Japanese Patent Application No. 2021-147188 filed on Sep. 9, 2021, the disclosure of which is incorporated by reference herein.

### BACKGROUND

### Technical Field

The present disclosure relates to an information processing device, an information processing method, and a storage medium stored with an information processing program.

### Related Art

Technology related to quantitative analysis of mineral phases in sintered ore using an XRD-Rietveld method is disclosed in “Quantitative Analysis of Mineral Phases in Sintered Ore by XRD-Rietveld Method” by Toni TAKAYAMA and Reiko MURANO in publication No. 408 of Nippon Steel & Sumitomo metal Corporation (2017). The technology disclosed in “Quantitative Analysis of Mineral Phases in Sintered Ore by XRD-Rietveld Method” by Toni TAKAYAMA and Reiko MURANO in publication No. 408 of Nippon Steel & Sumitomo metal Corporation (2017) employs the Rietveld method for fitting to an overall X-ray diffraction pattern using a least squares method to quantitatively analyze sintered ore.

However, there have hitherto been many analysis methods applied to materials such as disclosed in “Quantitative Analysis of Mineral Phases in Sintered Ore by XRD-Rietveld Method” by Toni TAKAYAMA and Reiko MURANO in publication No. 408 of Nippon Steel & Sumitomo metal Corporation (2017). Such analysis methods are methods that execute predetermined processing, and enable information related to which properties are exhibited by the material to be obtained by applying such analysis methods to the data obtained for the material.

However, information related to material properties might conceivably be obtained not only by using existing analysis methods as hitherto, but also by using a data-driven method based on data obtained from materials (for example, a data-driven machine learning method). For example, relationships and the like between plural sets of data are elucidated by using data-driven methods.

However, the technology disclosed in “Quantitative Analysis of Mineral Phases in Sintered Ore by XRD-Rietveld Method” by Toru TAKAYAMA and Reiko MURANO in publication No. 408 of Nippon Steel & Sumitomo metal Corporation (2017) merely employs an existing analysis method, and does not consider a data-driven method for data obtained from materials. There is accordingly an issue in that the technology of “Quantitative analysis of Mineral Phases in Sintered Ore by XRD-Rietveld Method” by Toru TAKAYAMA and Reiko MURANO in publication No. 408 of Nippon Steel & Sumitomo metal Corporation (2017) only applies a predetermined analysis method to material analysis, and is not able to obtain more information related to material properties.

An object of the present disclosure is to enable a user executing material analysis to obtain more information related to material properties.

### SUMMARY

An information processing device according to a first aspect is an information processing device including a reception section, a first analysis section, a second analysis section, and a transmission section. The reception section is configured to receive material data related to a material from a user terminal. The first analysis section is configured to perform analysis on the material data received by the reception section using a predetermined first analysis method and to generate first analysis result data that is an analysis result from the first analysis method. The second analysis section is configured to perform analysis on the material data received by the reception section using a second analysis method and to generate second analysis result data that is an analysis result expressing a relationship between the material data received by the reception section and data different from the received material data. The transmission section is configured to transmit the first analysis result data generated by the first analysis section and the second analysis result data generated by the generated second analysis section to the user terminal.

The information processing device receives the material data relating to the material transmitted from the user terminal. The information processing device performs analysis on the received material data with the predetermined first analysis method to generate the first analysis result data that is the analysis result from the first analysis method. The information processing device performs analysis on the received material data with the second analysis method to generate the second analysis result data that is the analysis result expressing a relationship between the received material data and data different to this material data. The information processing device transmits the generated first analysis result data and the generated second analysis result data to the user terminal. The user executing material analysis is accordingly able to obtain more information related to material properties.

In an information processing device according to a second aspect, the second analysis section generates the second analysis result data after aligning a numerical range of the material data received by the reception section to a specific numerical range. This enables second analysis result data to be generated appropriately even in cases in which numerical ranges differ between plural sets of material data.

In an information processing device according a third aspect, the second analysis section generates the second analysis result data after aligning a grid spacing of data contained in the material data received by the reception section to a specific grid spacing. This enables the second analysis result data to be generated appropriately even in cases in which the grid spacings of data contained in material data differ between plural sets of material data.

In an information processing device according to a fourth aspect, the second analysis result data is map data expressing relationships between plural sets of the material data, and the information processing device further includes a reconstruction section that, in cases in which a specific region has been specified on the map data, reconstructs the material data corresponding to the specific region. This enables the user to obtain more information related to which properties are exhibited by the material actually being analyzed.

In an information processing device according to a fifth aspect, the first analysis section stores the generated first analysis result data in a storage section and the second analysis section stores the generated second analysis result data in the storage section. This accordingly enables a user to check the first analysis result data and the second analysis result data later using the information processing device.

An information processing method according to a sixth aspect is an information processing method in which a computer executes processing. The processing includes receiving material data related to a material from a user terminal, performing analysis on the received material data using a predetermined first analysis method and generating first analysis result data that is an analysis result from the first analysis method, performing analysis on the received material data using a second analysis method to generate second analysis result data that is an analysis result expressing a relationship between the received material data and data different from the received material data, and transmitting the generated first analysis result data and the generated second analysis result data to the user terminal. This accordingly enables more information related to material properties to be obtained.

An information processing program according to a seventh aspect is an information processing program that causes a computer to execute processing. The processing includes receiving material data related to a material from a user terminal, performing analysis on the received material data using a predetermined first analysis method and generating first analysis result data that is an analysis result from the first analysis method, performing analysis on the received material data using a second analysis method to generate second analysis result data that is an analysis result expressing a relationship between the received material data and data different from the received material data, and transmitting the generated first analysis result data and the generated second analysis result data to the user terminal. This accordingly enables more information related to material properties to be obtained.

The present disclosure as described above exhibits the advantageous effect of enabling a user executing material analysis to obtain more information related to material properties.

### BRIEF DESCRIPTION OF THE DRAWINGS

FIG. 1 is a schematic block diagram of an information processing device according to an exemplary embodiment.

FIG. 2 is a diagram to explain an overview of an exemplary embodiment.

FIG. 3 is a diagram to explain an overview of first analysis result data.

FIG. 4 is a diagram to explain an overview of second analysis result data.

FIG. 5 is a diagram to illustrate an example of reconstruction processing.

FIG. 6 is a diagram to illustrate an example of reconstruction processing.

FIG. 7 is a diagram to illustrate an example of reconstruction processing.

FIG. 8 is a diagram to illustrate an example of reconstruction processing.

FIG. 9 is a diagram to illustrate an example of reconstruction processing.

FIG. 10 is a diagram illustrating an example of a configuration of a computer of a server and a user terminal according to an exemplary embodiment.

FIG. 11 is a flowchart illustrating an example of processing performed in an information processing device according to an exemplary embodiment.

### DETAILED DESCRIPTION

Explanation follows regarding an information processing system of an exemplary embodiment, with reference to the drawings.

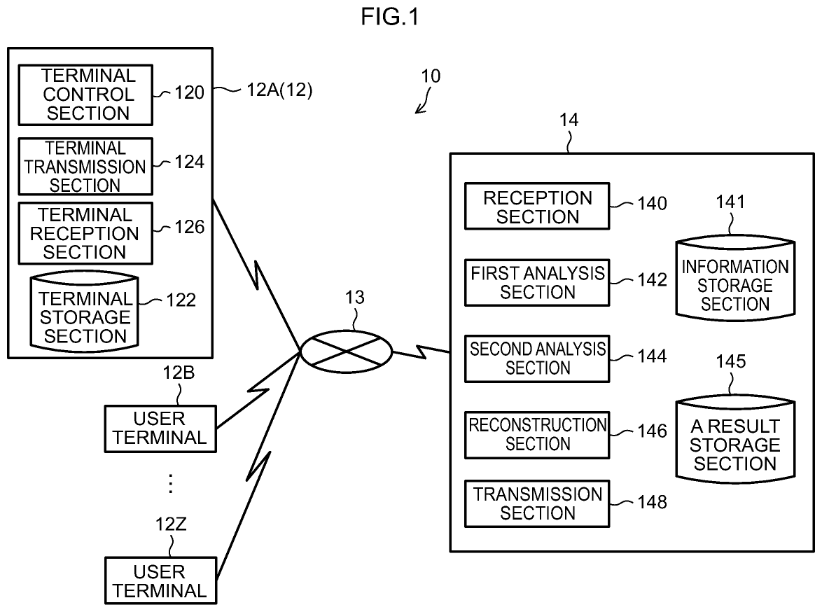

FIG. 1 is a block diagram illustrating an example of a functional configuration of an information processing system 10 according to an exemplary embodiment. As illustrated in FIG. 1, the information processing system 10 includes plural user terminals 12A, 12B, . . . , 12Z and a server 14 serving as an example of an information processing device. The plural user terminals 12A, 12B, . . . , 12Z and the server 14 are, for example, connected together through a network 13 such as the internet. Note that to indicate a single user terminal then this will simply be referred to below as user terminal 12.

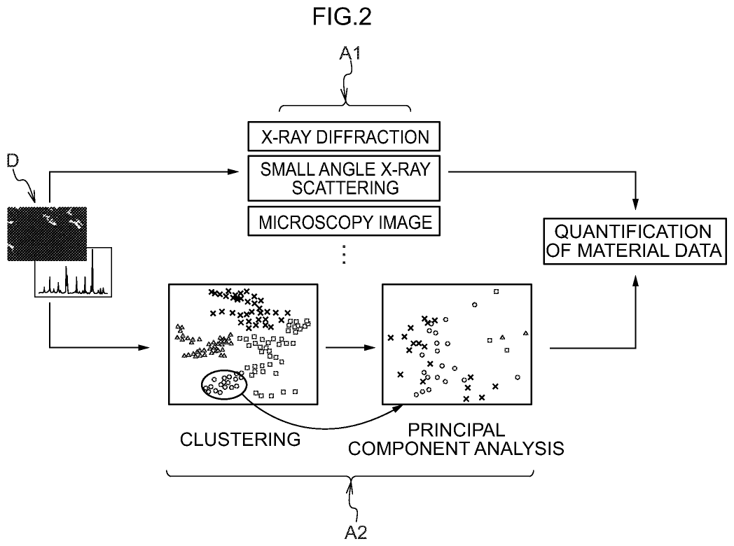

FIG. 2 is a diagram to explain an overview of processing of the information processing system 10 of the exemplary embodiment. As illustrated in FIG. 2, the information processing system 10 of the present exemplary embodiment quantifies material data by analyzing material data D using a first analysis method A1 and also analyzing the material data D using a second analysis method A2. The first analysis method A1 is, for example, an analysis method for material data, such as an analysis method employing X-ray diffraction, an analysis method employing small angle X-ray scattering, or an analysis method employing microscopy images. The second analysis method A2 is an analysis method for application to plural sets of material data such as, for example, a machine learning method, a clustering method, a principal component analysis method, uniform manifold approximation and projection (UMAP), or t-distributed stochastic neighbor embedding (t-sne) as analysis methods applied to plural sets of data. Sometimes A1 and A2 are each used alone, and sometimes A1 and A2 are used together.

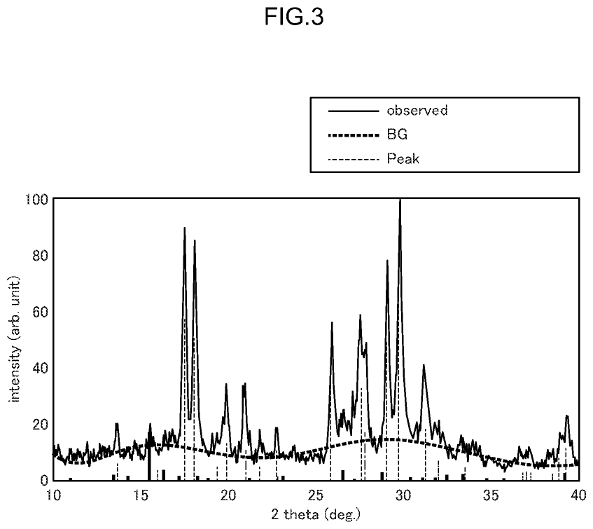

FIG. 3 illustrates an example of first analysis result data that is analysis results obtained using the first analysis method. The first analysis result data illustrated in FIG. 3 are material data obtained using an X-ray diffraction (XRD) method. In FIG. 3 “observed” indicates material data that has been observed, and “BG” indicates a background level. The first analysis result data illustrated in FIG. 3 is obtained using a specific analysis method employing an X-ray diffraction (XRD) method. The background level in the first analysis result data is, for example, employed to discriminate scattering in the material other than by the sample from scattering due to amorphous components of the material. The crystal phases and phase fractions etc. of the material are moreover determined from values of peak positions. Strain, crystal grain size, and boundaries are determined from the shape of the peaks.

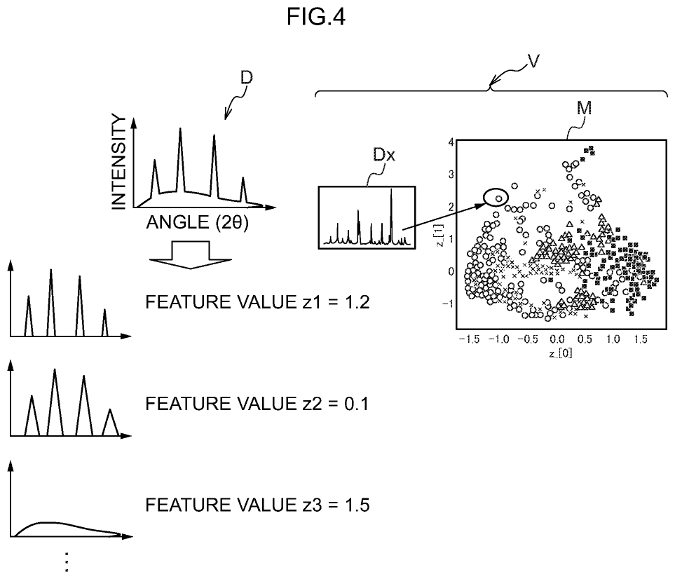

Next, an example will now be given of the second analysis result data in FIG. 4, this being analysis results obtained using the second analysis method. As illustrated by V in FIG. 4, plural plot points corresponding to each respective set of plural sets of material data are illustrated on a map M expressing the second analysis result data. One set of material data Dx corresponds to a single plot point on the map M expressing the second analysis result data. The plot points on the map M may be colored according to an ordered sequence of data or to numerical values obtained for each material (for example, performance values or manufacturing condition values etc. that are separate from the material data itself). Note that as illustrated in FIG. 4 these plot points are obtained by extracting specific feature values z from the material data D. The feature values z are, for example, extracted using a machine learning method or the like.

In the present exemplary embodiment material analysis is performed on the server 14 of the information processing system 10. More specifically, a user transmits material data to the server 14 using the user terminal 12. The server 14 then performs analysis on the received material data using the first analysis method and the second analysis method, and transmits first analysis result data and second analysis result data to the user terminal 12.

The user is thereby able to check both the first analysis result data and the second analysis result data, enabling more information relating to material properties to be obtained. More specifically, due to being able to check not only the first analysis result data, which is analysis results for one set of material data as illustrated in FIG. 3, but also being able to check relationships between plural sets of material data as illustrated in FIG. 4, the user is able to obtain more information related to which properties are exhibited by the material actually being analyzed. Moreover, the second analysis result data can also be utilized for predicting physical properties, such as which physical properties are expressed by a material having a given feature value.

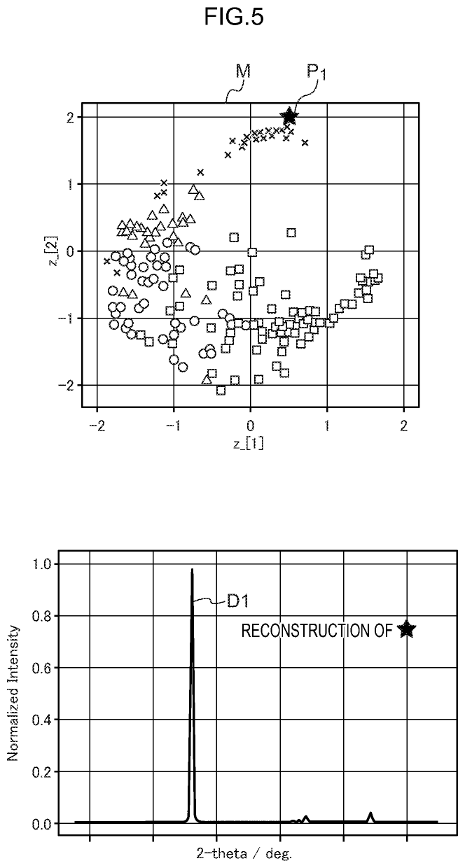

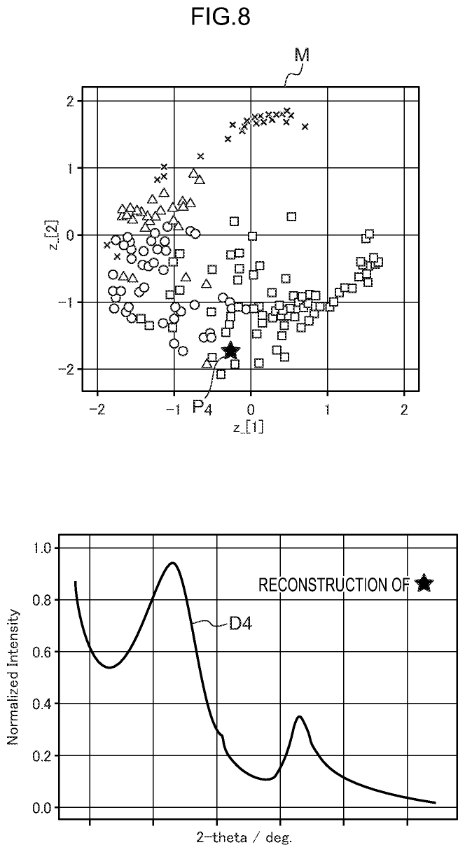

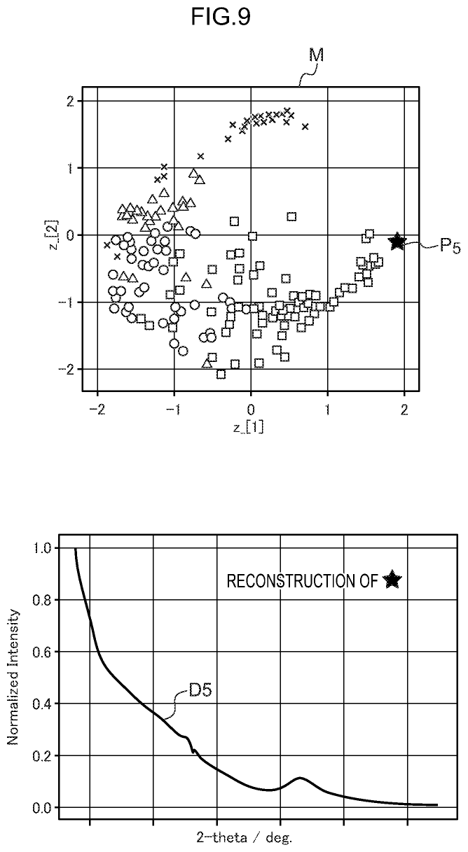

FIG. 5 to FIG. 9 illustrate diagrams for explaining the second analysis result data.

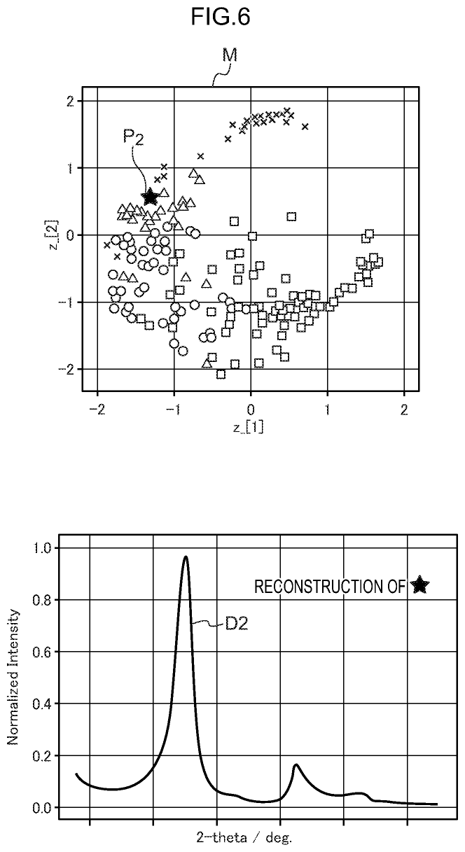

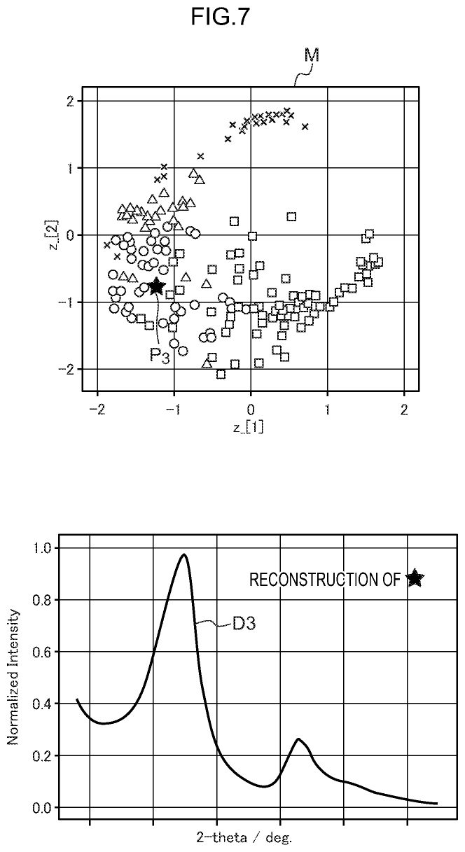

For example, a shape such as that of material data D1 of FIG. 5 results from reconstruction of a plot point P1 on the map M of the second analysis result data illustrated in FIG. 5 to produce material data measured using an XRD method. Moreover, a shape such as that of material data D2 of FIG. 6 results from reconstruction of a plot point P2 in the second analysis result data map M illustrated in FIG. 6 to produce material data measured using an XRD method. A shape such as that of material data D3 of FIG. 7 results from reconstruction of a plot point P3 in the second analysis result data map M illustrated in FIG. 7 to produce material data measured using an XRD method.

Thus due to being able to check the material data that is the basis of the second analysis result data by reconstructing the plot points in the second analysis result data, a user is able to obtain more information related to which properties are exhibited by the material actually being analyzed.

This is described more specifically below.

User Terminal

Each of the plural user terminals 12A, 12B, . . . , 12Z is operated by a different respective user.

As illustrated in FIG. 1, one user terminal 12 includes a terminal control section 120, a terminal storage section 122, a terminal transmission section 124, and a terminal reception section 126.

A user inputs material data of an analysis target into the user terminal 12 the user is operating themselves. The material data of the analysis target is data measured using an XRD method or the like, and is data that will be subjected to analysis by the server 14, described later.

When the terminal control section 120 receives the material data, the material data is temporarily stored in the terminal storage section 122 according to operation by the user.

Material data is stored in the terminal storage section 122.

The terminal transmission section 124 and the terminal reception section 126 exchange data with the server 14.

Under control from the terminal control section 120, the terminal transmission section 124 transmits display data of a combination of the material data stored in the terminal storage section 122 together with a user ID expressing identification information of the user terminal 12 to the server 14.

Note that the processing described above as being executed in the user terminal 12 may be executed under control from the server 14. For example, a specific screen may be displayed on a display section (not illustrated in the drawings) of the user terminal 12 by the server 14 outputting a control signal to the user terminal 12, such that various processing is executed by the user operating the user terminal 12 according to instructions being displayed on the screen.

Server

As illustrated in FIG. 1, the server 14 includes a reception section 140, an information storage section 141, a first analysis section 142, a second analysis section 144, a result storage section 145, a reconstruction section 146, and a transmission section 148.

The reception section 140 receives data representing the combination of material data and user ID that was transmitted from the user terminal 12.

The combination of the material data and user ID received by the reception section 140 is stored in the information storage section 141. Note that plural sets of material data that has been transmitted in the past from the user terminal 12 are also stored in the information storage section 141. Note that plural sets of material data transmitted from other user terminals 12 may also be stored in the information storage section 141.

The first analysis section 142 performs analysis on the material data received by the reception section 140 using the predetermined first analysis method, and generates the first analysis result data that is the results of analysis by the first analysis method.

The second analysis section 144 uses the second analysis method to perform analysis on the plural sets of material data stored in the information storage section 141, including the material data received this time by the reception section 140, and generates the second analysis result data, which are analysis results expressing relationships between the material data received this time by the reception section 140 and different data to this material data.

For example, the second analysis section 144 generates the second analysis result data expressing relationships between plural sets of material data transmitted from the same user terminal 12 in the past and the material data transmitted this time from the user terminal 12. Alternatively, for example, the second analysis section 144 generates the second analysis result data expressing relationships between material data transmitted from a given user terminal 12A and plural sets of the material data transmitted from user terminals 12B, 12C. The second analysis result data is, for example, map data such as that of maps M in FIG. 5 to FIG. 9.

Note that the second analysis section 144 generates the second analysis result data after first aligning a numerical range of the material data received by the reception section 140 to a specific numerical range. The second analysis section 144 also generates the second analysis result data after first aligning the grid spacing of data contained in the material data received by the reception section 140 to a specific grid spacing.

For example, there are sometimes cases in which the numerical ranges differ between the material data transmitted from the given user terminal 12A and the plural sets of material data transmitted from the user terminals 12B, 12C. For example, whereas the numerical range of the material data transmitted from the given user terminal 12A might be a range from 0to 10, the numerical range of the plural sets of material data transmitted from the user terminals 12B, 12C might be a range from 0 to 5. In such cases the respective material data is not able to be projected onto a map expressing the second analysis result data, and so the second analysis section 144 generates the second analysis result data after first aligning the numerical range of the material data to the specific numerical range.

Moreover, for example, whereas the XRD material data transmitted from the given user terminal 12A might be in gradations of 0.5 degrees, the XRD material data transmitted from the user terminals 12B, 12C might be in gradations of 0.1 degree. In such cases too, a map is not able to be generated appropriately to express the second analysis result data, and so the second analysis section 144 generates the second analysis result data after first aligning the grid spacing for data in the material data to the specific grid spacing.

The first analysis section 142 stores the first analysis result data in the result storage section 145 in association with the user IDs. The second analysis section 144 also stores the second analysis result data in the result storage section 145 in association with the user IDs.

The result storage section 145 is stored with the first analysis result data and the second analysis result data. This accordingly enables the user to check the first analysis result data and the second analysis result data later.

The transmission section 148 transmits the first analysis result data generate by the first analysis section 142 and the second analysis result data generated by the second analysis section 144 to the user terminal 12. The user operating the user terminal 12 checks the first analysis result data and the second analysis result data.

The user operating the user terminal 12 then, for example, specifies a specific region in the second analysis result data by clicking on the specific region of the map M of the second analysis result data. The user terminal 12 then, according to operation by the user, transmits information related to the specified region of the map M in the second analysis result data to the server 14.

The reconstruction section 146 of the server 14 reconstructs material data corresponding to the specific region based on the information related to the specified region on the map M of the second analysis result data transmitted from the user terminal 12. For example, the reconstruction section 146 reconstructs material data as illustrated in FIG. 5 to FIG. 9.

The transmission section 148 then transmits the data obtained by the reconstruction section 146 to the user terminal 12.

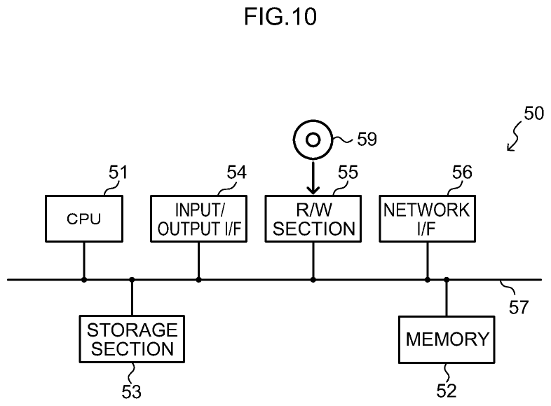

The user terminal 12 and the server 14 are capable of, for example, being implemented by a computer 50 such as that illustrated in FIG. 10. The respective computer 50 that implements the user terminal 12 and the server 14 includes a CPU 51, memory 52 serving as a temporary storage area, and a non-volatile storage section 53. The computer 50 also includes an input/output interface (I/F) 54 connected to an input/output device or the like (not illustrated in the drawings), and a read/write (R/W) section 55 for controlling the reading and writing of data to a recording medium 59. The computer also includes a network I/F 56 connected to a network such as the internet. The CPU 51, the memory 52, the storage section 53, the input/output I/F 54, the R/W section 55, and the network I/F 56 are connected together through a bus 57.

The storage section 53 may be implemented by a hard disk drive (HDD), a solid state drive (SSD), flash memory, or the like. A program to cause the computer to function is stored in the storage section 53 serving as a storage medium. The CPU 51 reads the program from the storage section 53, expands the program in the memory 52, and sequentially executes the processes of the program.

Next, description follows regarding operation of the information processing system 10 of the exemplary embodiment.

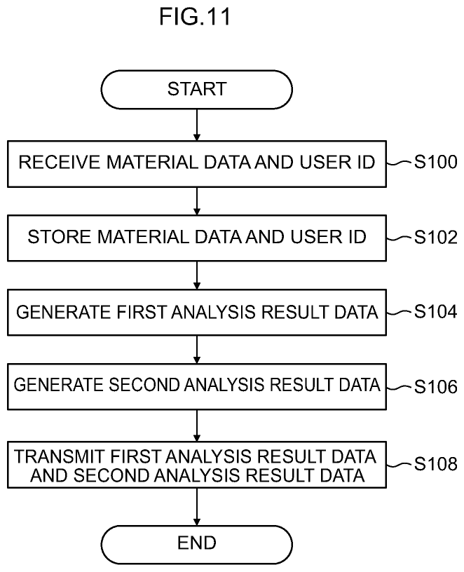

When training material data has been input to the user terminal 12, a combination of material data and user ID is transmitted to the server 14 under control from the terminal control section 120. When this combination of data has been transmitted from the user terminal 12 to the server 14, the server 14 then executes an information processing routine as illustrated in FIG. 11.

At step S100 the reception section 140 of the server 14 receives the material data and user ID combination that was transmitted from the user terminal 12.

At step S102, the reception section 140 stores the material data and user ID in the information storage section 141.

At step S104 the first analysis section 142 uses the first analysis method to perform analysis on the material data received at step S100 so as to generate the first analysis result data.

At step S106 the second analysis section 144 uses the second analysis method to perform analysis on the plural sets of material data stored in the information storage section 141, including the material data received at step S100, so as to generate the second analysis result data.

At step S108 the transmission section 148 transmits the first analysis result data generated at step S104 and the second analysis result data generated at step S106 to the user terminal 12.

The user operating the user terminal 12 checks the first analysis result data and the second analysis result data. The user operating the user terminal 12 then, for example, specifies a specific region of the second analysis result data by clicking the specific region on the map M of the second analysis result data, and material data corresponding to the specific region is reconstructed by the reconstruction section 146 of the server 14.

This thereby enables the user to obtain more information related to which properties are exhibited by the material actually being analyzed.

As described above, the server in the information processing system according to the exemplary embodiment receives the material data relating to the material that was transmitted from the user terminal. The server performs analysis on the material data received with the predetermined first analysis method so as to generate the first analysis result data that is the analysis results by the first analysis method. The server performs analysis on the received material data using the second analysis method, and generates the second analysis result data that is the analysis results expressing relationships between the received material data and data different to this material data. The server transmits the first analysis result data and the second analysis result data to the user terminal. The user is thereby able to obtain more information related to properties exhibited by the material. Moreover, being overlooked by a human and the individuality of analysis can be excluded. Analysis of large volumes of data is moreover enabled.

For example, phase identification utilizing the positions of peaks and the derivation of crystal grain size utilizing the widths of the peaks are possible by using the first analysis method to analyze material data obtained using an XRD method. However, analysis that contains both the overall shape of the peaks and the background level, and feature value extraction are difficult to achieve by analysis using the first analysis method alone. In contrast thereto, the present exemplary embodiment utilizes all of the material data in the second analysis method, and so is able to exclude preconceptions of the user and overlooking by the user.

Note that although the processing performed by each device in the exemplary embodiment described above has been described as software processing by executing a program, processing may be performed by hardware. Alternatively processing may be performed by a combination of both software and hardware. The program stored on the ROM may also be distributed stored on various types of storage medium.

Furthermore, the present disclosure is not limited by the description above, and obviously various other modifications may be implemented within a range not departing from the spirit of the present disclosure.

All publications, patent applications, and technical standards mentioned in this specification are herein incorporated by reference to the same extent as if each individual publication, patent application, or technical standard was specifically and individually indicated to be incorporated by reference.

What is claimed is:

1. An information processing device comprising:
a memory; and
a processor coupled to the memory,
wherein the processor is configured to:
receive material data related to a material, from a user terminal,
perform analysis on the material data using a predetermined first analysis method and generate first analysis result data that is an analysis result from the first analysis method,
perform analysis on the received material data using a second analysis method and generate second analysis result data that is an analysis result expressing a relationship between the received material data and data different from the received material data, and
transmit the generated first analysis result data and the generated second analysis result data to the user terminal.

2. The information processing device of claim 1, wherein the processor generates the second analysis result data after aligning a numerical range of the received material data to a specific numerical range.

3. The information processing device of claim 1, wherein the processor generates the second analysis result data after aligning a grid spacing of data contained in the received material data to a specific grid spacing.

4. The information processing device of claim 1, wherein:
the second analysis result data is map data expressing relationships between a plurality of sets of the material data; and
in a case in which a specific region has been specified on the map data, the processor reconstructs the material data corresponding to the specific region.

5. The information processing device of claim 1, wherein:
the processor stores the generated first analysis result data in a storage section; and
the processor stores the generated second analysis result data in the storage section.

6. An information processing method comprising:
by a processor,
receiving material data related to a material, from a user terminal;
performing analysis on the material data using a predetermined first analysis method and generating first analysis result data that is an analysis result from the first analysis method;
performing analysis on the material data using a second analysis method to generate second analysis result data that is an analysis result expressing a relationship between the material data and data different from the material data; and
transmitting the generated first analysis result data and the generated second analysis result data to the user terminal.

7. A storage medium storing an information processing program executable by a computer to perform processing comprising:
receiving material data related to a material, from a user terminal;
performing analysis on the material data using a predetermined first analysis method and generating first analysis result data that is an analysis result from the first analysis method;
performing analysis on the material data using a second analysis method to generate second analysis result data that is an analysis result expressing a relationship between the material data and data different from the material data; and
transmitting the generated first analysis result data and the generated second analysis result data to the user terminal.
